(19) United States
(12) Patent Application Publication
(10) Pub. No.: US 2012/0044134 A1
(43) Pub. Date: Feb. 23, 2012

(54) LIQUID CRYSTAL DISPLAY APPARATUS

(75) Inventor: Kohei Nanbu, Osaka (JP)

(73) Assignee: SHARP KABUSHIKI KAISHA, Osaka (JP)

(21) Appl. No.: 13/266,640

(22) PCT Filed: Mar. 5, 2010
(86) PCT No.: PCT/JP2010/053654

§ 371 Date: Nov. 8, 2011

(30) Foreign Application Priority Data
Apr. 28, 2009 (JP) 2009-108753

(51) Int. Cl. G09G 3/36

(52) U.S. Cl. 345/102

(57) ABSTRACT

Provided is a liquid crystal display apparatus having a heat dissipation mechanism which can effectively dissipate heat generated in a heat generating part generating a large amount of heat. The liquid crystal display apparatus includes a liquid crystal panel, a backlight, a backlight chassis (70), and a wiring substrate (75) to which at least one heat generating part (90) is electrically connected. The heat generating part is mounted on a heat dissipation plate (80) through which heat generated by the heat generating part is dissipated. The region of the heat dissipation plate on which the heat generating part is mounted is spatially separated from the substrate to form an air passage (87). At least a portion of the heat dissipation plate is attached to the backlight chassis so as to conduct heat from the heat generating part to the backlight chassis through the heat dissipation plate.

### TECHNICAL FIELD

The present invention relates to a liquid crystal display apparatus, and more particularly, to a liquid crystal display apparatus provided with a heat dissipation mechanism that dissipates heat generated by a heat generating part such as a semiconductor device and the like.

The present application claims priority to Japanese Patent Application No. 2009-108753 filed on Apr. 28, 2009. The entire contents of which are hereby incorporated by reference.

### BACKGROUND ART

With the increase of the size of a liquid crystal panel and the like in recent years, the amount of heat generated by a heat generating part (typically, a power device such as a MOSFET and the like) such as a heat generating semiconductor device and the like that is used in a liquid crystal display apparatus is also on the rise. On the other hand, in order to realize a space saving for the depth of the liquid crystal display apparatus, reduction of the thickness (space saving) is being pursued. In such a thin type liquid crystal display apparatus, it is necessary to efficiently dissipate heat from the heat generating part.

Conventionally, as a measure to dissipate heat generated by a heat generating part such as a power device and the like, a heat dissipation plate 130 is attached to a heat generating part 120, as shown in FIG. 7. However, since the heat dissipation plate 130 is only in contact with the heat generating part 120, there is a problem of not achieving enough heat dissipation effect.

In Patent Document 1, a heat dissipation apparatus for heat generating parts that insures a heat dissipation area of the heat dissipation plate by making the cross section of the heat dissipation plate L shaped is disclosed as a technique in the art. Also, in Patent Document 2, a chassis that provides heat dissipation as a component of a plasma display panel (PDP) is disclosed.

### RELATED ART DOCUMENTS

### Patent Documents

Patent Document 1: Japanese Patent Application Laid-Open Publication No. 2001-203306

Patent Document 2: Japanese Patent Application Laid-Open Publication No. H11-233968

### SUMMARY OF THE INVENTION

### Problems to be Solved by the Invention

If a technique that increases heat dissipation effect by more efficiently utilizing the heat dissipation area of a heat dissipation plate and more efficiently dissipates heat generated by a heat generating part can be provided, this technique is useful. Also, it is preferable that a limited space be efficiently utilized by adopting a simple structure in order to increase the heat dissipation effect and that the structure can realize a liquid crystal display apparatus that is light and thin.

In view of the above, the present invention seeks to address the problems of the liquid crystal display apparatus provided with the heat generating part described above. An object of the present invention is to provide a liquid crystal display apparatus including a heat dissipation mechanism that can efficiently dissipate heat generated by a heat generating part generating a large amount of heat.

### Means for Solving the Problems

In order to realize the object, a liquid crystal display apparatus provided by the present invention includes a liquid crystal panel that displays images, a backlight that irradiates light to the liquid crystal panel, a backlight chassis that supports the backlight, and a wiring substrate disposed on a rear side of the backlight chassis, wherein at least one heat generating part is electrically connected to the wiring substrate, and the heat generating part is mounted on to a heat dissipation plate that dissipates heat generated by the heat generating part. Here, the heat dissipation plate is configured so that a space between a region where the heat generating part is mounted on the heat dissipation plate and the wiring substrate is spatially separated and an air passage is formed therein, and at least a portion of the heat dissipation plate is attached to the backlight chassis so as to conduct the heat from the heat generating part to the backlight chassis through the heat dissipation plate.

In such a configuration of the liquid crystal display apparatus of the present invention, the air passage (that is, a space through which air can flow) is formed between the heat dissipation plate and the wiring substrate and the portion of the heat dissipation plate is attached to the backlight chassis.

Accordingly, because of this simple structure of forming the air passage between the heat dissipation plate and the wiring substrate, the surface area of the heat dissipation plate that can come in contact with the air can be increased in the liquid crystal display apparatus of the present invention. In addition, the heat generated by the heat generating part can be effectively dissipated in the air by the air going in and out of the air passage (the space portion). Further, because the portion of the heat dissipation plate is attached to the backlight chassis (typically, a metallic backlight chassis), the heat generated by the heat generating part can be dissipated through the heat dissipation plate. Furthermore, because heat is dissipated in the air from the backlight chassis also in a similar manner to the heat dissipation plate, the heat generated by the heat generating part can be dissipated even more efficiently and damages to the part itself due to a rise in temperature of the heat generating part can be prevented.

In a preferred embodiment of the liquid crystal display apparatus disclosed herein, a portion of the heat dissipation plate penetrates through the wiring substrate and is connected to a region of the backlight chassis directly underneath the wiring substrate.

In such a configuration of the liquid crystal display apparatus, the portion of the heat dissipation plate does not need to be attached to the area of the backlight chassis that is beyond the wiring substrate. That portion can be attached to the area of the backlight chassis with the are of the wiring substrate. Thus, the heat generated by the heat generating part can be dissipated efficiently utilizing a limited space.

In a preferred embodiment of the liquid crystal display apparatus disclosed herein, the heat dissipation plate is provided without physically touching the wiring substrate.

In such a configuration of the liquid crystal display apparatus, a heat dissipation plate does not have legs, and the heat dissipation plate does not need to be attached to the wiring substrate. Also, since the heat dissipation plate is completely separated from the wiring substrate, the surface area that comes in contact with the air is large and the heat generated by the heat generating part can be dissipated effectively in the air. Further, since the heat dissipation plate is attached to the backlight chassis, the heat generated by the heat generating part is conducted to the backlight chassis through the heat dissipation plate. The heat is dissipated also from the backlight chassis into the air in a similar manner to the heat dissipation plate. Thus, the heat generated from the heat generating part can be even more effectively dissipated. Also, the heat generated from the heat generating part is prevented from being conducted to the wiring substrate, and damages to the wiring substrate (and to a variety of electronic parts mounted on the wiring substrate) by the heat can be prevented before they occur.

In a preferred embodiment of the liquid crystal display apparatus disclosed herein, a cabinet enclosing the backlight chassis is disposed on the rear side of the backlight chassis, and the heat dissipation plate is attached to an inner surface of the cabinet facing the substrate. Also, it is configured so that a space between the region where the heat generating part is mounted on the heat dissipation plate and the cabinet is spatially separated and an air passage is formed therein.

In such a configuration of the liquid crystal display apparatus, a limited space can be effectively utilized by attaching legs of the heat dissipation plate to the cabinet even when there is no space for attaching the legs to the wiring substrate. In addition, stability of the heat dissipation plate can be maintained. Also, heat generated by the heat generating part is conducted to the cabinet through the heat dissipation plate and the heat is dissipated in the air from the cabinet. Further, since an air passage is also formed between the heat dissipation plate and the cabinet, the surface area of the heat dissipation plate that can come in contact with the air increases. Thus, the heat generated by the heat generating part can be dissipated in the air more effectively by the air going in and out of the air passage.

In a preferred embodiment of the liquid crystal display apparatus disclosed herein, the heat generating part mounted on the heat dissipation plate is a power device (for example, FET such as IGBT or MOSFET), and the wiring substrate to which the device is electrically connected is an inverter substrate.

Particularly because the inverter substrate for lighting the backlight takes up the majority of the power consumption, heat is likely to be generated and temperature rise of the power device (typically, a MOSFET) for driving a transformer is comparatively high. In such a configuration of the liquid crystal display apparatus, the heat generated by the power device such as a high heat generating MOSFET (Metal-Oxide-Semiconductor FET) and the like can be dissipated effectively. Thus, damages to the power device (MOSFET and the like) can be prevented.

### BRIEF DESCRIPTION OF THE DRAWINGS

FIG. 1 is a schematic cross sectional view showing a configuration of a liquid crystal display apparatus according to an embodiment of the present invention.

FIG. 2 is a schematic exploded perspective view showing a configuration of a liquid crystal display apparatus according to an embodiment of the present invention.

FIG. 3 is a schematic cross sectional view along the line III-III in FIG. 1 showing a configuration of a heat dissipation mechanism according to an embodiment of the present invention.

FIG. 4 is a schematic cross sectional view showing a configuration of a heat dissipation mechanism according to another embodiment of the present invention.

FIG. 5 is a schematic cross sectional view showing a configuration of a heat dissipation mechanism according to another embodiment.

FIG. 6 is a schematic cross sectional view showing a configuration of a heat dissipation mechanism according to another embodiment.

FIG. 7 is a schematic perspective view showing a heat dissipation mechanism using a conventional flat plate heat dissipation plate.

### DETAILED DESCRIPTION OF EMBODIMENTS

With reference to the drawings, preferred embodiments of the present invention are described below. Here, matters necessary for embodying the present invention (for example, configuration of and method of constructing the liquid crystal panel, electric circuits related to drive method of light sources provided in the liquid crystal display apparatus and the like) that are outside of the matters particularly mentioned in the present specification can be taken as design matters to one of ordinary skill in the art based on conventional techniques. The present invention can be embodied based on the contents disclosed in the present specification and common techniques and knowledge in the art.

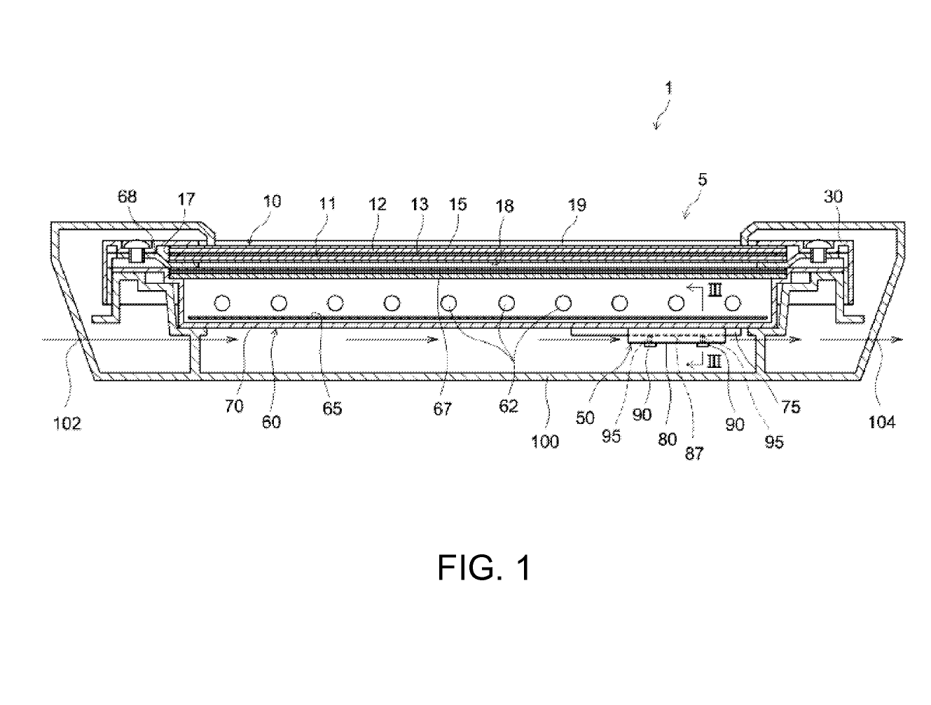

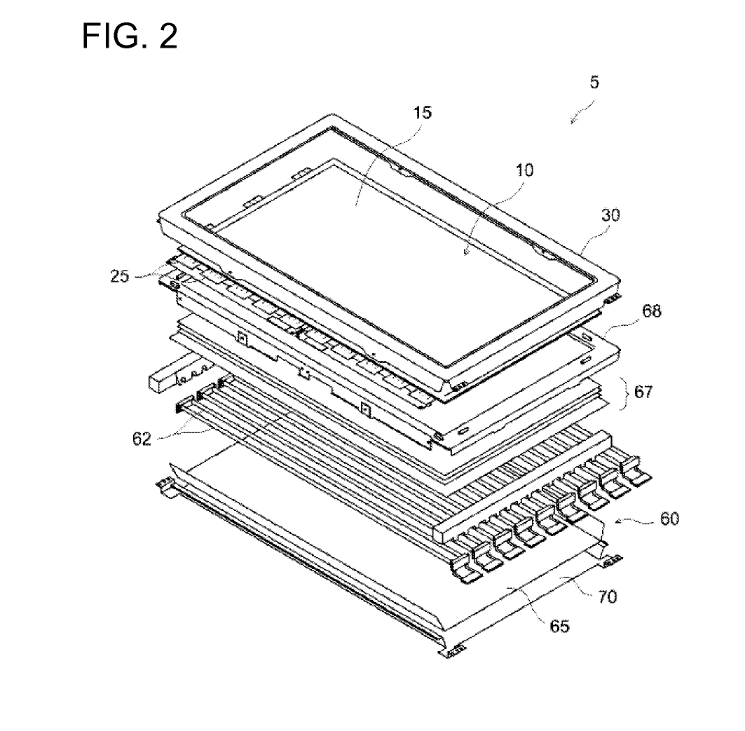

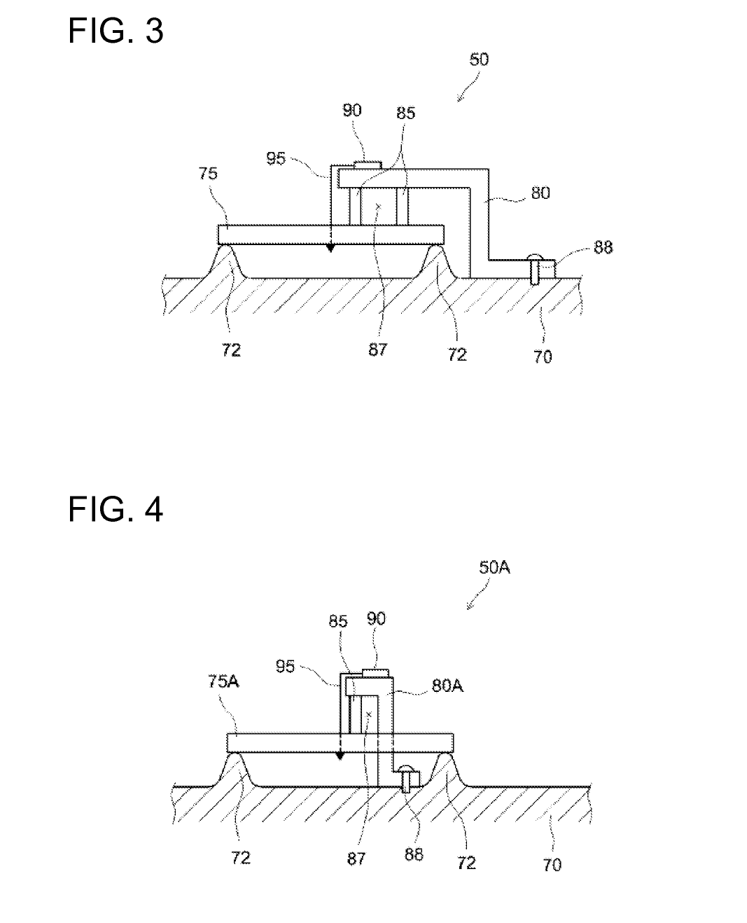

With reference to FIGS. 1 to 3, a liquid crystal display apparatus 1 provided with a heat dissipation mechanism 50 according to a preferred embodiment (Embodiment 1) of the present invention is described below. FIG. 1 is a schematic cross sectional view showing a configuration of the liquid crystal display apparatus 1 according to an embodiment of the present invention. FIG. 2 is a schematic exploded perspective view showing a configuration of a liquid crystal display apparatus body 5 according to an embodiment of the present invention. FIG. 3 is a schematic cross sectional view taken along the line III-III of FIG. 1 showing a configuration of the heat dissipation mechanism 50.

In the following drawings, the same reference characters are assigned to the members and parts that have the same functionalities, and redundant descriptions may be omitted or simplified. Also, the dimensional relationships (length, width, thickness and the like) in each of the drawings do not necessarily reflect the actual dimensional relationships accurately. Also, in the following description, the side facing the viewer (that is, the side of the liquid crystal panel 10) in the liquid crystal display apparatus 1 is called “front” and “front side”, and the side not facing the viewer (that is, the side of the backlight apparatus 60) in the liquid crystal display apparatus 1 is called “back” or “back side”.

With reference to FIGS. 1 and 2, the configuration of the liquid crystal display apparatus 1 is described. As shown in FIG. 1, the liquid crystal display apparatus 1 is constituted by the liquid crystal display apparatus body 5 including the liquid crystal panel 10 and a cabinet 100 enclosing the display apparatus body 5. The display apparatus body 5 is a term broadly encompassing devices, parts, members, and the like as a whole that are enclosed in the cabinet 100. The display apparatus body 5 mainly includes the liquid crystal panel 10 and the backlight apparatus 60 that is the external light source disposed on the back side (bottom side in FIG. 1) of the liquid crystal panel 10. The liquid crystal panel 10 and the backlight apparatus 60 are integrally supported by being assembled with a bezel 30 or the like.

As shown in FIG. 1 and FIG. 2, the liquid crystal panel 10 generally has a rectangular shape as a whole. In its central area, the liquid crystal panel 10 has a display area 15 where pixels are formed to display images. Also, this liquid crystal panel 10 has a sandwich structure constituted by a pair of translucent glass substrates 11 and 12 that are facing each other and a liquid crystal layer 13 encapsulated therebetween. Cutout portions from a large base material called mother glass are used in the manufacturing steps for the substrates 11 and 12, respectively. Of the pair of substrates 11 and 12, the one on the front side is a color filter substrate (CF substrate) 12 and the one on the back side is an array substrate 11. Here, a sealing member 17 is provided on the periphery (periphery of the liquid crystal panel 10) of the substrates 11 and 12 so as to surround the perimeter of the display area 15 and seals the liquid crystal layer 13. The liquid crystal layer 13 is constituted by a liquid crystal material including liquid crystal molecules. In such a liquid crystal material, the orientation of liquid crystal molecules is manipulated by the electric field that is applied between the substrates 11 and 12, and therefore, the optical characteristics change. In the liquid crystal layer 13, spacers (not shown) for securing the thickness (gap) of the layer 13 are disposed at a plurality of locations typically. Also, alignment films (not shown) that determine the orientation of liquid crystal molecules are formed on respective surfaces of the sides (inner sides) of both substrates 11 and 12 that are facing each other. On surfaces of the sides (outer sides) that are not facing each other, respective polarizing plates 18 and 19 are attached.

In the liquid crystal panel 10 disclosed herein, pixels for displaying images are arranged on the front side (the side facing the liquid crystal layer 13) of the array substrate 11, and a plurality of source wires and gate wires (not shown) for driving the respective pixels are formed to exhibit lattice-like patterns. A thin film transistor (TFT), which is a switching device, and a (sub) pixel electrode are provided on each lattice region surrounded by such wires. The pixel electrode is typically made of ITO (Indium Tin Oxide), which is a transparent conductive material. A voltage corresponding to images is applied to these pixel electrodes through the source wire and through the thin film transistor at a prescribed timing.

On the other hand, on the CF substrate 12, one of R (red), G (green), or B (blue) color filters is facing one of the pixel electrodes on the array substrate 11. A black matrix that partitions the respective color filters and a common electrode (transparent electrode) that is formed uniformly on surfaces of the color filters and the black matrix are provided on the CF substrate 12.

Also, as shown in FIG. 2, the source wires and the gate wires are connected to external driver circuits (driver ICs) 25 provided typically on the periphery of the liquid crystal panel 10. The external driver circuits 25 are capable of supplying image signals and the like.

Here, the configuration of the pixels and the wiring itself of the electrodes may be similar to the case of manufacturing a conventional liquid crystal panel, and they do not characterize the present invention. Thus, any further detailed descriptions are omitted.

As shown in FIG. 1 and FIG. 2, the backlight apparatus 60 as a backlight in the present embodiment is constituted by a plurality of linear light sources (for example, fluorescent tubes, typically cold cathode tubes) 62 and a metallic (for example, highly thermally conductive aluminum plate) backlight chassis 70 that supports the light sources 62. The backlight chassis 70 has a box like shape with an opening facing the front side. Inside the chassis 70, the light sources 62 are arranged in parallel. Between the chassis 70 and the light sources 62, a reflective member 65 that efficiently reflects the light from the light sources 62 toward the viewer side is disposed.

Also, a plurality of sheet like optical members 67 are laminated and disposed in the opening of the chassis 70 so as to cover the opening. The optical members 67 are constituted by a diffusion plate, a diffusion sheet, a lens sheet, and a luminance increase sheet in this order from the side of the backlight apparatus 60, for example. However, they are not limited to this combination and order. Further, a substantially rim shaped frame 68 is provided to the chassis 70 in order to support the optical members 67 by sandwiching them with the chassis 70.

The liquid crystal display apparatus body 5 including the liquid crystal panel 10, the backlight apparatus 60, and the like as configured above is enclosed in a thin rim-like shaped (frame shaped) cabinet 100 that is made of a nonflammable, non-halogen series resin material, for example.

Next, with reference to FIG. 1 and FIG. 3, the configuration of the heat dissipation mechanism 50 of the liquid crystal display apparatus 1 in the present embodiment is described. The heat dissipation mechanism 50 is generally constituted by the backlight chassis 70, an inverter substrate (wiring substrate) 75, a MOSFET (heat generating part) 90 that is a power device electrically connected to the wiring substrate 75, and a heat dissipation plate 80.

The inverter substrate (wiring substrate) 75 for mounting an inverter circuit and an inverter transformer (not shown), which is a step-up circuit for supplying power to each of the light sources 62, are provided on the back side of the backlight chassis 70. The inverter transformer includes an inverter (not shown), which converts a direct current voltage to a high frequency voltage, and a transformer (not shown), which steps up the high frequency voltage to a high voltage. Further, the inverter includes the MOSFET 90 that constitutes the switching device (power device). The MOSFET 90 is the electronic part corresponding to the heat generating part 90 in the present embodiment.

As show in FIG. 3, protrusions 72 for attaching the inverter substrate (wiring substrate) 75 are formed integrally with the backlight chassis 70 by press work on the rear side of the backlight chassis 70 (the surface on the back side of the backlight chassis 70). Also, the inverter substrate 75 is fixed to the backlight chassis 70 by mechanically fixing the inverter substrate 75 to the protrusion 72 using screws or the like.

On the inverter substrate 75, the MOSFET 90 that is the heat generating part of the present embodiment is electrically connected to the inverter substrate 75 by fixing a lead wire 95 of the MOSFET 90 on the back side of the substrate 75 using soldering. Here, the lead wire 95 penetrates through the substrate 75. However, fixing the lead wire 95 is not limited to penetrating through the inverter substrate 75. The lead wire 95 may also be fixed on the front side of the substrate 75 using soldering.

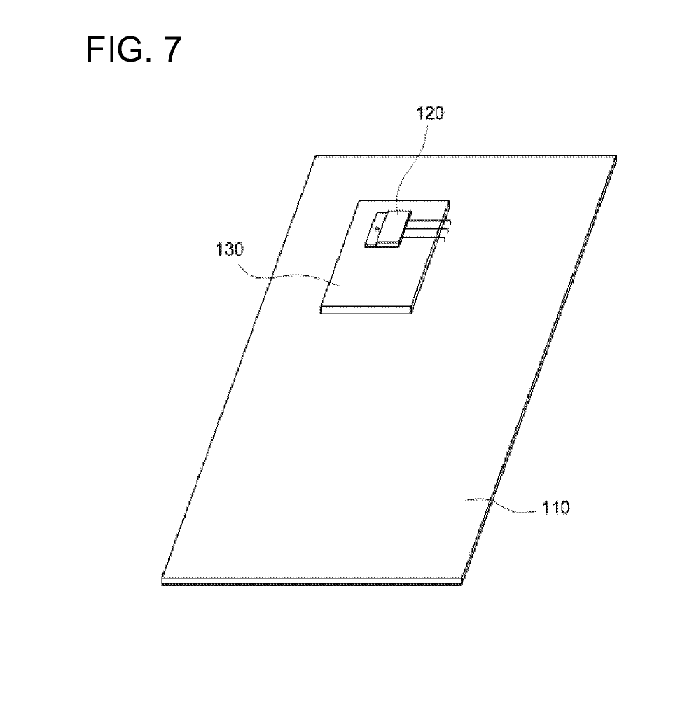

Further, the MOSFET 90 is mounted on the heat dissipation plate 80 that dissipates the heat generated by the MOSFET 90. The heat dissipation plate is formed using a material having a good heat conductivity, such as aluminum, copper, or iron. The heat dissipation plate is formed, for example, by extrusion molding, metallic molding or the like so that the cross sectional shape is a step-like shape. Here, the heat dissipation plate 80 of the present embodiment differs from the configuration in which the heat dissipation plate 130 on which a heat generating part 120 is mounted is attached to the wiring substrate 110 so that their respective surfaces are in close contact with each other as in a conventional technique shown in FIG. 7. Legs 85 of the heat dissipation plate 80 are attached to the inverter substrate 75 so as to form an air passage 87 by spatially separating the space between the region where the MOSFET 90 on the heat dissipation plate 80 is mounted and the inverter substrate 75. This way, almost the entire back surface of the heat dissipation plate that was in close contact with the wiring substrate in the conventional technique is in contact with the air. Thus, the heat dissipation area of the heat dissipation plate increases and even more effective heat dissipation can be realized.

Further, a portion of the heat dissipation plate 80 is attached to the backlight chassis 70 by a screw 88 or the like. This way, the heat generated by the MOSFET 90 can be conducted to the backlight chassis 70 through the heat dissipation plate 80 and heat dissipation becomes possible also through the backlight chassis 70.

Here, the air around the MOSFET (heat generating part) 90 is warmed by the heat generated by the MOSFET 90 and an updraft is generated by the chimney effect, as shown in FIG. 1. This way, the air flows in from an air intake 102 formed in the cabinet 100, and the air is discharged through an air exhaust 104. Thus, by forming the air passage 87 in the same direction as the updraft when the heat dissipation plate 80 is fixed to the backlight chassis 70, even more efficient heat dissipation effect can be realized. Accordingly, the heat dissipation plate 80 is preferably attached to the backlight chassis 70 in the position that is parallel to the direction of the updraft.

Next, with reference to FIG. 4, Embodiment 2 is described. FIG. 4 is a schematic cross sectional view showing a configuration of a heat dissipation mechanism 50A of Embodiment 2 and corresponds to FIG. 3 showing the heat dissipation mechanism 50 of Embodiment 1.

As shown in FIG. 4, the heat dissipation mechanism 50A of Embodiment 2 differs from the heat dissipation mechanism 50 of Embodiment 1 in the attachment configuration of the heat dissipation plate. That is, in the present embodiment, a heat dissipation plate 80A penetrates through an inverter substrate 75A and is attached to a region of the backlight chassis 70 that is directly underneath the substrate 75A by a screw 88 or the like. The space between the region where the MOSFET 90 is mounted on the heat dissipation plate 80A and the inverter substrate 75 is spatially separated and an air passage 87 is formed therein. In such an attachment configuration of the heat dissipation plate 80A, the heat generated by the MOSFET 90 can be effectively dissipated. Further, since the portion where the heat dissipation plate 80A is attached to the backlight chassis 70 is within the area of the inverter substrate 75A in the width direction, it is not necessary to newly secure a space for attaching the heat dissipation plate 80A to the backlight chassis 70. Thus, an efficient usage of the limited space is possible.

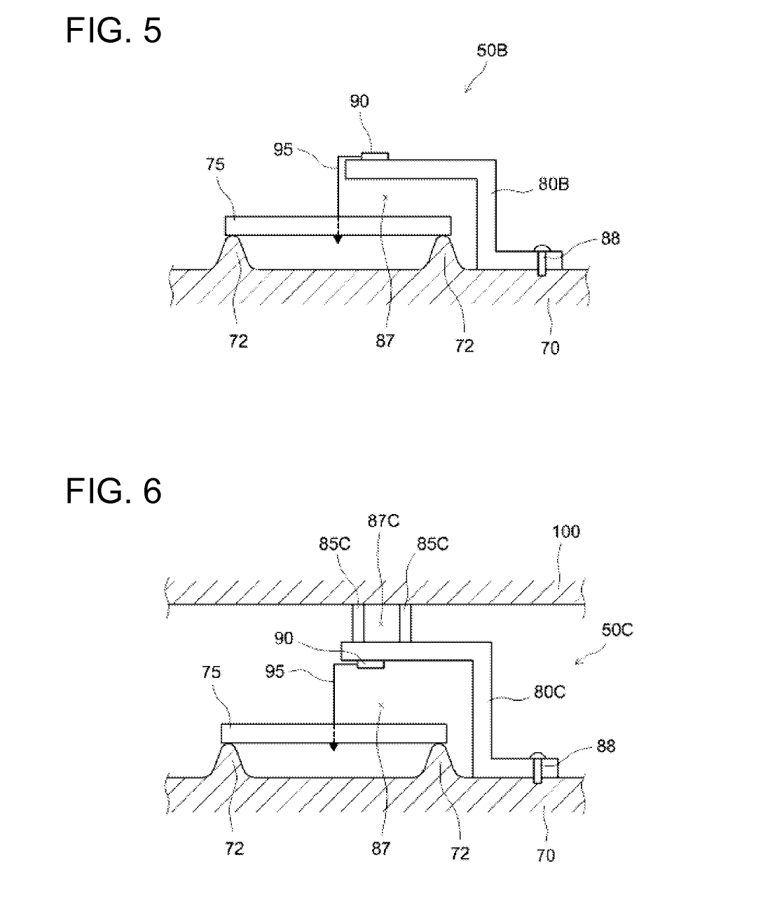

Next, with reference to FIG. 5, Embodiment 3 is described. FIG. 5 is a schematic cross sectional view showing a configuration of a heat dissipation mechanism 50B of Embodiment 3 and corresponds to FIG. 3 showing the heat dissipation mechanism 50 of Embodiment 1.

As shown in FIG. 5, the heat dissipation mechanism 50B in Embodiment 3 differs from the heat dissipation mechanisms 50 and 50A of Embodiments 1 and 2 in that a heat dissipation plate 80B is provided so as not to physically come in contact with the inverter substrate 75. The space between the region where the MOSFET 90 is mounted on the heat dissipation plate 80B and the inverter substrate 75 is spatially separated and the air passage 87 is formed therein. In this case, the heat dissipation plate 80B having enough strength needs to be formed so that the end portion does not hang down by its own weight. In such an attachment configuration of the heat dissipation plate 80B, the heat generated by the MOSFET 90 can be effectively dissipated. Further, because the heat dissipation plate 80B does not require legs for mounting to the inverter substrate 75, the space on the front surface of the substrate 75 can be effectively utilized. Furthermore, since the heat dissipation plate 80B is only attached to the backlight chassis 70, attachment becomes easy.

Next, with reference to FIG. 6, Embodiment 4 is described. FIG. 6 is a schematic cross sectional view showing a configuration of a heat dissipation mechanism 50C of Embodiment 4 and corresponds to FIG. 3 showing the heat dissipation mechanism 50 of Embodiment 1.

As shown in FIG. 6, the heat dissipation mechanism 50C of Embodiment 4 differs from the above described various embodiments in that a portion of the heat dissipation plate 80C is attached to the backlight chassis 70 and other portions of the heat dissipation plate 80C are attached to an internal surface (surface on the front side of the cabinet 100) of the cabinet 100. That is, legs 85C of the heat dissipation plate 80C are attached to the internal surface of the cabinet 100 so that the space between the region where the MOSFET 90 is mounted on the heat dissipation plate 80C and the cabinet 100 is spatially separated and an air passage 87C is formed therein. Also, the space between the region where the MOSFET 90 is mounted on the heat dissipation plate 80C and the inverter substrate 75 is spatially separated and the air passage 87 is formed therein. In such an attachment configuration of the heat dissipation plate 80C, the heat generated by the MOSFET 90 can be effectively dissipated. Further, the heat generated by the MOSFET 90 is conducted to the cabinet 100 through the legs 85 of the heat dissipation plate 80C. Thus, the heat can be dissipated also from the cabinet 100.

Here, the heat dissipation plate 80C may penetrate through the inverter substrate 75 and be attached to the backlight chassis 70 directly underneath the substrate 75 as described above.

Preferred embodiments of the present invention have been described as above. However, these descriptions are not limiting the scope of the present invention. Of course, there can be other variations, modifications and alternatives.

For example, the present invention can be applied to a power supply substrate and a main substrate attached to the rear side of the backlight chassis 70 as well. Also, fins can be formed on the heat dissipation plate in order to improve the heat dissipation effect.

### INDUSTRIAL APPLICABILITY

According to the present invention, a liquid crystal display apparatus in which an air passage is formed between a heat dissipation plate and a wiring substrate and a portion of the heat dissipation plate is attached to a backlight chassis is provided. The liquid crystal display apparatus can dissipate heat generated by a heat generating part, which generates a large amount of heat, effectively in the air, because the surface area of the heat dissipation plate that can come in contact with the air is large. Also, the heat can be conducted to the backlight chassis through the heat dissipation plate. Therefore, damages to the heat generating part due to the rise in temperature of the part can be prevented before they occur.

### DESCRIPTION OF REFERENCE CHARACTERS

1 liquid crystal display apparatus

5 liquid crystal display apparatus body

10 liquid crystal panel

11, 12 glass substrates

13 liquid crystal layer

15 display area

17 sealing member

18, 19 polarizing plates

25 external driver circuit

30 bezel

50, 50A, 50B, 50C heat dissipation mechanisms

60 backlight apparatus

62 light source

65 reflective member

67 optical member

68 frame

70 backlight chassis

72 protrusion

75, 75A inverter substrates (wiring substrates)

80, 80A, 80B, 80C heat dissipation plates

85, 85C legs

87, 87C air passages

88 screw

90 MOSFET (heat generating part)

95 lead wire

100 cabinet

102 air intake

104 air exhaust

110 wiring substrate

120 heat generating part

130 heat dissipation plate

1. A liquid crystal display apparatus comprising:
a liquid crystal panel that displays images;
a backlight that irradiates light to the liquid crystal panel;
a backlight chassis that supports the backlight; and
a wiring substrate disposed on a rear side of the backlight chassis,
wherein at least one heat generating part is electrically connected to the wiring substrate, and the heat generating part is mounted onto a heat dissipation plate that dissipates heat generated by the heat generating part,
wherein a space between a region where the heat generating part is mounted on the heat dissipation plate and the wiring substrate is spatially separated to form an air passage therein, and
wherein at least a portion of the heat dissipation plate is attached to the backlight chassis so that the heat generated from the heat generating part can be conducted to the backlight chassis through the heat dissipation plate.

2. The liquid crystal display apparatus according to claim 1, wherein a portion of the heat dissipation plate penetrates through the wiring substrate and is connected to a region of the backlight chassis directly underneath the wiring substrate.

3. The liquid crystal display apparatus according to claim 1, wherein the heat dissipation plate is provided so that the heat dissipation plate is not physically in contact with the wiring substrate.

4. The liquid crystal display apparatus according to claim 1,
wherein a cabinet enclosing the backlight chassis is disposed on the rear side of the backlight chassis, and
wherein the heat dissipation plate is attached to an inner surface of the cabinet facing the wiring substrate, and a space between the region where the heat generating part is mounted on the heat dissipation plate and the cabinet is spatially separated to form an air passage therein.

5. The liquid crystal display apparatus according to claim 1, wherein the heat generating part is a power device mounted on the heat dissipation plate and the wiring substrate is an inverter substrate to which the power device is electrically connected.
